(19) United States
(12) Patent Application Publication
(10) Pub. No.: US 2021/0298385 A1
(43) Pub. Date: Sep. 30, 2021

(54) RESPIRATOR AND FILTRATION DEVICES

(71) Applicant: BIOAID, INC., Santa Rosa, CA (US)

(72) Inventors: Marcus G. HAYS, San Rafael, CA (US); Scott STREETER, Santa Rosa, CA (US); Martin WINDMILL, Petaluma, CA (US)

(73) Assignee: BIOAID, INC., Santa Rosa, CA (US)

(21) Appl. No.: 17/213,051

(22) Filed: Mar. 25, 2021

Related U.S. Application Data
(60) Provisional application No. 62/994,828, filed on Mar. 25, 2020.
(60) Provisional application No. 63/007,868, filed on Apr. 9, 2020.
(60) Provisional application No. 63/052,866, filed on Jul. 16, 2020.
(60) Provisional application No. 63/090,600, filed on Oct. 12, 2020.
(60) Provisional application No. 63/136,136, filed on Jan. 11, 2021.
(60) Provisional application No. 63/148,547, filed on Feb. 11, 2021.
(60) Provisional application No. 63/154,697, filed on Feb. 27, 2021.

(51) Int. Cl. A41D 13/11; A62B 23/02; A62B 9/02

(52) U.S. Cl. CPC A41D 13/1176; A62B 9/02; A62B 23/025

(57) ABSTRACT

A face mask includes a mask shell and a replaceable filter. The mask shell defines a cavity configured to at least partially receive a wearer's nostrils and mouth. The mask shell includes an aperture formed in the mask shell and a flange. The flange is disposed on an inner portion of an edge of the mask shell. The flange is configured to follow a contour of the wearer's face. The flange is configured to contact the wearer's face at least at a nasal bridge portion, a chin portion, a left cheek portion, and a right cheek portion. The replaceable filter is coupled to the mask shell and is configured to cover the aperture.

### CROSS-REFERENCE TO RELATED APPLICATIONS

This application claims the benefit of U.S. Provisional Patent Application Nos. 62/994,828, filed on Mar. 25, 2020, titled “BLISTER PACK RESPIRATORS AND METHODS AND MANUFACTURING AND USE”, 63/007,868, filed Apr. 9, 2020, titled “MASS-PRODUCTION AND LOW-COST RESPIRATORS WITH THERMOFORMED MASK SHELLS AND METHODS OF MANUFACTURING AND USE”, 63/052,866, filed Jul. 16, 2020, titled “METHOD AND MEDIA FOR SUBMICRON PARTICULATE FILTRATION”, 63/090,600, filed Oct. 12, 2020, titled “FILTER BANDAGE DEVICES, ASSEMBLIES, AND METHODS”, 63/136,136, filed Jan. 11, 2021, titled “REUSABLE RESPIRATORS, FILTRATION ASSEMBLIES AND METHODS”, 63/148,547, filed Feb. 11, 2021, titled “MASKS WITH FILTRATION PORTION AND CLOTH OUTER SURFACE”, and 63/154,697, filed Feb. 27, 2021, titled “REUSABLE RESPIRATORS, FILTRATION ASSEMBLIES AND METHODS”, each of which is incorporated herein by reference in its entirety.

### FIELD

The present application generally relates to respirator and filtration devices, and more particularly but not exclusively, to reusable face masks with removable and reusable filters.

### BACKGROUND

Unless otherwise indicated herein, the materials described herein are not prior art to the claims in the present application and are not admitted to be prior art by inclusion in this section.

Face masks have long been used in the medical field to provide protection to healthcare workers and patients from airborne illnesses, germs, and other airborne contaminants. Further, due to recent world health related issues, face masks have become a common feature for all people as a factor in preventing further spread of disease.

Some face masks may be less effective by loosely fitting about the wearer's face such that air and related particulates easily pass from an exterior portion of the face mask to an interior portion of the face mask and vice versa. Some face masks attempt to remedy the loose fit by including tight bands configured to wrap around the wearer's ears, head, and/or neck, which may cause discomfort during use.

The subject matter claimed in the present disclosure is not limited to embodiments that solve any disadvantages or that operate only in environments such as those described above. Rather, this background is only provided to illustrate one example technology area where some embodiments described in the present disclosure may be practiced.

### SUMMARY

In one embodiment, a face mask includes a mask shell and a replaceable filter. The mask shell defines a cavity configured to at least partially receive a wearer's nostrils and mouth. The mask shell includes an aperture formed in the mask shell and a flange. The flange is disposed on an inner portion of an edge of the mask shell. The flange is configured to follow a contour of the wearer's face. The flange is configured to contact the wearer's face at least at a nasal bridge portion, a chin portion, a left cheek portion, and a right cheek portion. The replaceable filter is coupled to the mask shell and is configured to cover the aperture.

In another embodiment, a face mask includes a mask shell, a replaceable filter, and one or more elongated attachment members. The mask shell defines a cavity configured to at least partially receive a wearer's nostrils and mouth. The mask shell is configured to contact the wearer's face at least at a nasal bridge portion, a chin portion, a left cheek portion, and a right cheek portion. The mask shell includes an aperture formed in the mask shell, a first coupling member located adjacent to the aperture, and one or more tie attachment members. The replaceable filter is configured to cover the aperture. The replaceable filter includes a second coupling member complementary to the first coupling member. The replaceable filter covers the aperture when the first coupling member interfaces with the second coupling member. The elongated attachment members are coupled to the one or more tie attachment members.

In another embodiment, a reusable filter includes a first multiple of semicircular fibers and a second multiple of semicircular fibers. The first multiple of semicircular fibers include a first flat portion and a rounded portion. The first multiple of semicircular fibers are parallel to each other and the first flat portion of the first multiple of semicircular fibers lies in a first plane. The second multiple of semicircular fibers include a second flat portion. The second multiple of semicircular fibers are parallel to each other and the second flat portion of the second multiple of semicircular fibers lies in a second plane. The first multiple of semicircular fibers are disposed on and coupled to the second multiple of semicircular fibers at a rotational offset. The first plane is parallel and superior to the second plane. The first multiple of semicircular fibers and the second multiple of semicircular fibers define a filter chamber.

These and other aspects, features and advantages may become more fully apparent from the following brief description of the drawings, the drawings, the detailed description of preferred embodiments and appended claims.

### BRIEF DESCRIPTION OF THE DRAWINGS

Example embodiments will be described and explained with additional specificity and detail through the use of the accompanying drawings in which:

FIG. 1A is a perspective view of a face mask;

FIG. 1B is a rear, perspective view of the face mask of FIG. 1;

FIG. 2 is an exploded, perspective view of an alternative embodiment of a face mask;

FIG. 3 is a perspective view of an alternative embodiment of a face mask;

FIG. 4A is a rear view of another alternative embodiment of a face mask with an improperly fitted replaceable filter;

FIG. 4B is a rear view of the embodiment of a face mask of FIG. 4A with a properly fitted replaceable filter;

FIG. 4C is a perspective view of the embodiment of a face mask of FIG. 4A with an improperly fitted replaceable filter;

FIG. 4D is a perspective view of the embodiment of a face mask of FIG. 4A with a properly fitted replaceable filter;

FIG. 5 is a front view of another alternative embodiment of a face mask;

FIG. 6 is a perspective view of another alternative embodiment of a face mask with a replaceable filter;

FIG. 7A is a cross-sectional view of a filter that may be used with a face mask;

FIG. 7B is a perspective view of the filter that may be used with a face mask;

FIG. 8 is an exploded, perspective view of another alternative embodiment of a face mask;

FIG. 9 is a rear view of a cloth portion of the face mask of FIG. 8; and

FIG. 10 is an exploded, perspective view of another alternative embodiment of a face mask.

### DESCRIPTION OF EMBODIMENTS

Masks have long been used to aid in the prevention of spreading germs, reducing the inhalation of dust, allergens, and other particulates, and/or other health related functions in connection with breathing. Recently, due to a world-wide pandemic, an increase in demand for masks has increased at a rate greater than the supply of masks could fulfill. As such, shortages of masks that include effective filters were common. Some embodiments of the present disclosure provide various masks and filters that may be directed to increasing the number of masks, while maintaining an effectiveness of the filters, and reducing associated waste thereof.

These and other embodiments of the present disclosure will be explained with reference to the accompanying figures. It is to be understood that the figures are diagrammatic and schematic representations of such example embodiments, and are not limiting, nor are they necessarily drawn to scale. In the figures, features with like numbers indicate like structure and function unless described otherwise.

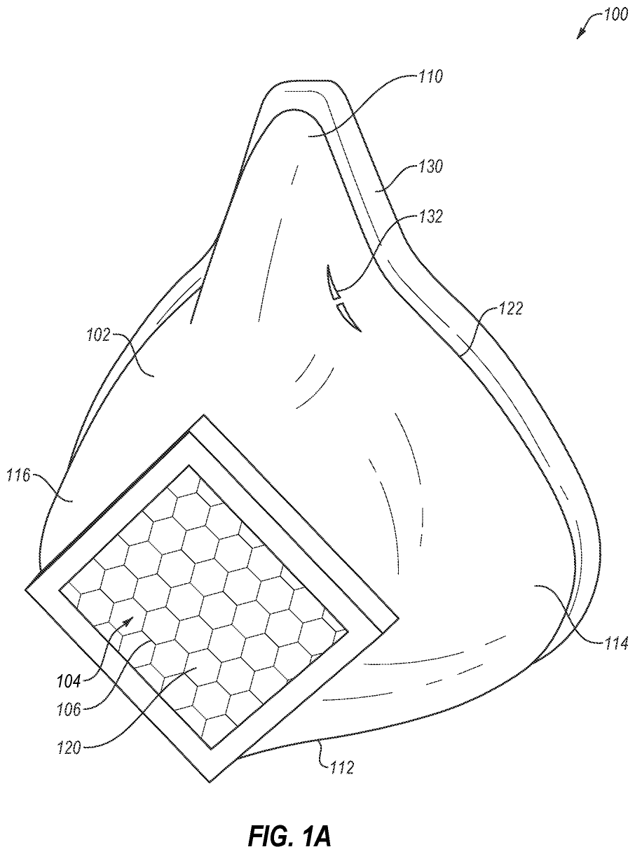

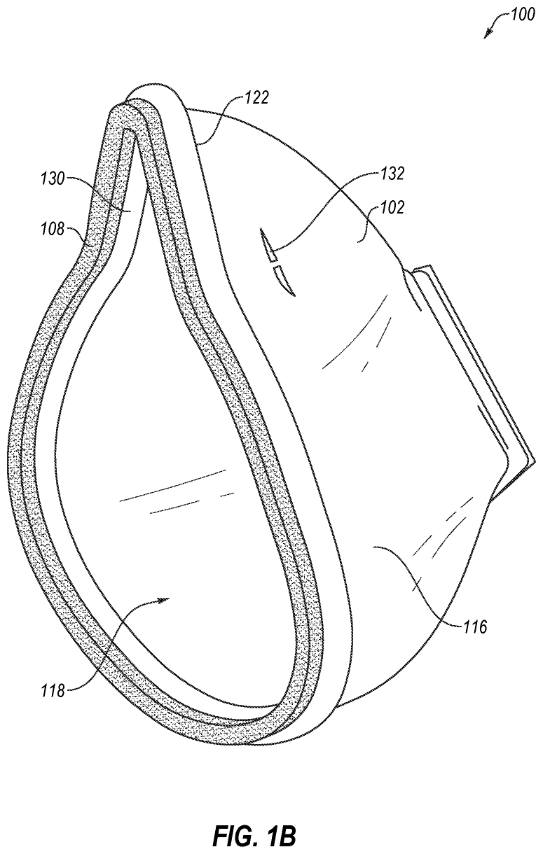

FIGS. 1A and 1B are a front, perspective view of a face mask 100 and a rear, perspective view of the face mask 100, respectively, in accordance with at least one embodiment described in the present disclosure. The face mask 100 may include a mask shell 102, an aperture 104, an aperture grille 106, a flange 108, a nasal bridge portion 110, a chin portion 112, a left cheek portion 114, a right cheek portion 116, a cavity 118 a filter 120, a proximal edge, 122, a seal 130, and a pressure release valve 132.

In some embodiments, the mask shell 102 may define the cavity 118 of the face mask 100 and/or may be configured to receive at least a portion of the wearer's nostrils and mouth in the cavity 118. For example, the mask shell 102 may include the nasal bridge portion 110, which may be an elongated portion that extends away from a central portion of the mask shell 102 and may be configured to cover the wearer's nose. For example, the nasal bridge portion 110 may include a similar shape as the wearer's nose and may be configured to cover the wearer's nose up to the wearer's nasal bridge. In some embodiments, the left cheek portion 114 and the right cheek portion 116 of the mask shell 102 may include rounded out portions that may be configured to contact and/or cover the wearer's left and right cheeks. In some embodiments, the chin portion 112 of the mask shell 102 may include a rounded inferior portion that may be configured to contact and/or cover the wearer's chin. For example, the chin portion 112 may contact an inferior portion of the wearer's chin such that the wearer's chin may be included in the cavity 118 of the mask shell 102. Alternatively or additionally, the chin portion 112 may contact an anterior portion of the wearer's chin such that the wearer's chin may be excluded from the cavity 118 of the mask shell 102.

In some embodiments, the mask shell 102 may include flexible materials that may be configured to follow the contours of the wearer's face. For example, the mask shell 102 may include flexible materials that may flex and/or stretch to conform to the contours of the wearer's face when in use. In these and other embodiments, the mask shell 102 may include thermoplastic materials. For example, the mask shell 102 may include polyethylene (PE), low-density polyethylene (LDPE), high-density polyethylene (HDPE), polyvinylidene fluoride (PVDF), polyethylene terephthalate (PET), polyvinyl chloride (PVC), polychlorotrifluoroethylene (PCTFE), PVC and/or PCTFE laminated on PVC and/or cyclic olefin copolymer (COC), acrylonitrile butadiene styrene (ABS), high impact polystyrene (HIPS), polyethylene terephthalate glycol-modified (PETG), and/or other thermoplastic materials and/or combinations of the aforementioned materials. In some embodiments, the mask shell 102 may include clear materials such that the mask shell 102 is transparent and the wearer's mouth and/or nose may be visible with the mask shell 102 in place covering the wearer's nose and/or mouth. Alternatively or additionally, the mask shell 102 may include a material varying in clarity such that the mask shell 102 may be translucent, opaque, and/or any degree of visibility between transparent and opaque.

In some embodiments, the mask shell 102 may include an aperture 104. Alternatively or additionally, the mask shell 102 may include more than one aperture 104. In some embodiments, the aperture 104 may be geometrically shaped such as a circle, oval, square, rectangle, and/or other geometric shapes. Alternatively or additionally, the aperture 104 may include any shape or arrangement of shapes. In some embodiments, the aperture 104 may be disposed in the mask shell 102 to substantially align with the wearer's mouth and/or nose, such as in a central portion of the mask shell 102. For example, the aperture 104 may be located in front of the wearer's mouth such that a substantial portion of exhaled and/or inhaled air from breathing is aimed in the direction of the aperture 104. Alternatively or additionally, the aperture 104 may be disposed off-center in the mask shell 102. For example, in instances in which two apertures 104 are disposed in the mask shell 102, the two apertures 104 may be disposed symmetrically across a vertical center line, such as a midline of the wearer's face, and the two apertures 104 may be located over the wearer's cheeks.

In some embodiments, the aperture 104 may be substantially planar with an outer surface of the mask shell 102. For example, the mask shell 102 may include a curved outer surface and the aperture 104 may be in the same plane as the curved outer surface. Alternatively or additionally, the aperture 104 may include a raised portion of the mask shell 102, such that the aperture 104 is raised above the plane of the mask shell 102. For example, the outer surface of the mask shell 102 may define a first plane and the aperture 104 may lie in a second plane, which second plane may be elevated (e.g., further from the wearer's face) relative to the first plane.

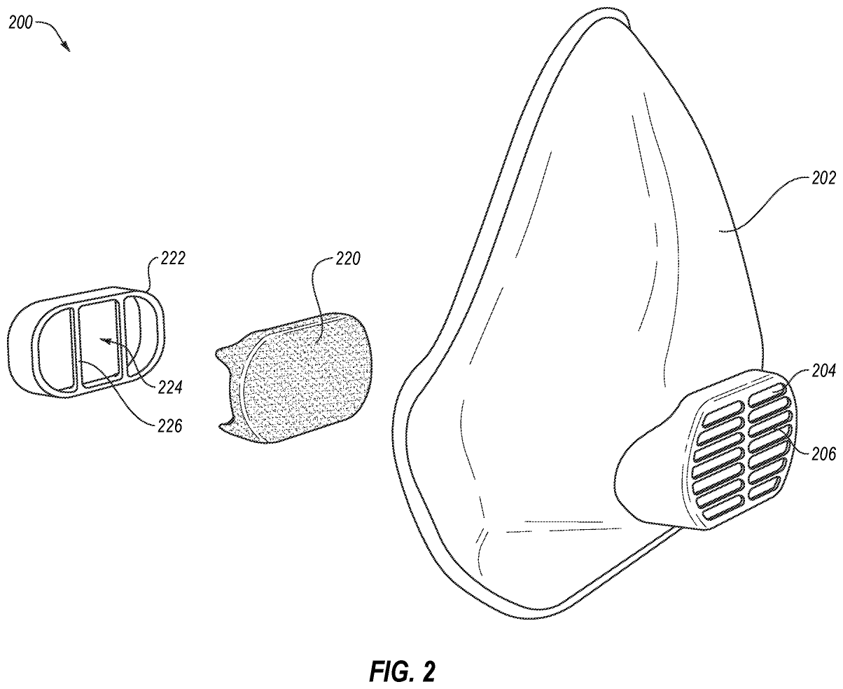

In some embodiments, the aperture 104 may be divided into smaller apertures. For example, the mask shell 102 may include a vertical divider that may separate the aperture 104 into two smaller apertures (e.g., see FIG. 8). Alternatively or additionally, the aperture grille 106 may divide the aperture 104 into smaller apertures (e.g., see FIGS. 2 and 8). In some embodiments, the aperture grille 106 may be formed of the same material as the mask shell 102. For example, the mask shell 102 may include one or more segments of material that may cover a partial portion of the aperture 104. Alternatively or additionally, the aperture grille 106 may include a different material from the mask shell 102 and may be configured to fit in and be retained within the aperture 104. For example, the aperture grille 106 may include a metallic mesh configured to fit between the filter 120 and the aperture 104, such that the filter 120 may be restricted from exiting the mask shell 102 through the aperture 104. In some embodiments, the aperture 104 may include a rim disposed around the edge thereof such that the aperture grille 106 may flush against the rim, in which the rim may retain the aperture grille 106 from passing from an internal portion of the mask shell 102 to an external portion of the mask shell 102.

In some embodiments, the mask shell 102 may include impermeable materials such that liquids and gasses may not be able to pass through the materials of the mask shell 102. For example, the thermoplastic materials of the mask shell 102 (e.g., as described above) may be impermeable to liquids and/or gasses such that transfers of liquids and/or gasses between an interior and exterior portion of the mask shell 102 may be directed through the aperture 104 and/or the pressure release valve 132. In instances in which the filter 120 is positioned to cover the aperture 104, liquids and/or gasses may be directed through the filter 120 such that the liquids and/or gasses transferring between an interior and exterior portion of the mask shell 102 may be filtered.

In some embodiments, an amount of gasses expelled in an interior portion of the mask shell 102 may include a greater volume than may freely pass through the aperture 104 and/or the filter 120. In these and other embodiments, the pressure release valve 132 may be disposed in the mask shell 102 which may permit additional expiration of gasses in circumstances where the volume is greater than can be passed through the aperture 104 and/or the filter 120. In some embodiments, more than one pressure release valve 132 may be disposed on the mask shell 102. For example, multiple pressure release valves 132 may be disposed throughout the mask shell 102. In these and other embodiments, the pressure release valve 132 may direct the extra gasses laterally away from the wearer of the face mask 100. In some embodiments, the pressure release valve 132 may be configured to prevent air from flowing from an exterior portion of the mask shell 102 to an interior portion of the mask shell 102. For example, in instances in which the wearer inhales, the pressure release valve 132 may remain closed such that air flowing from an exterior portion of the mask shell 102 to an interior portion of the mask shell 102 may be directed through the aperture 104 and/or the filter 120.

In some embodiments, the flange 108 may be disposed on an interior portion of the mask shell 102. For example, the flange 108 may extend around some or all of the perimeter of the interior portion of the mask shell 102. In some embodiments, the flange 108 may be disposed at or near the edge of the mask shell 102, the edge that may be configured to contact the wearer's face. For example, the flange 108 may be located around the entire interior perimeter of the mask shell 102 and may be configured to be in contact with the wearer's face. Alternatively or additionally, the flange 108 may be disposed on portions of the mask shell 102 that may be more likely to separate from the wearer's face. For example, the flange 108 may be disposed adjacent to the wearer's nasal bridge and/or one or both sides of the wearer's mouth. In some embodiments, the flange 108 may be adjacent to or flush with the proximal edge 122 of the mask shell 102, where the proximal edge 122 may be an edge configured to contact the face of the wearer.

In some embodiments, the flange 108 may include the same materials as the mask shell 102. Alternatively or additionally, the flange 108 may include materials different from the mask shell 102, which may enable the flange 108 to better follow and remain in contact with the contours of the wearer's face. For example, the mask shell 102 may include a first material and the flange 108 may include a second material, different from the first material, such that the flange 108 may remain in contact with the wearer's face in instances where the mask shell 102 may separate from the wearer's face.

In some embodiments, the seal 130 may be disposed on the proximal edge 122 of the mask shell 102 and may be configured to contact the wearer's face. In some embodiments, the seal 130 may be included in addition to or in the alternative to the flange 108. For example, both the seal 130 and the flange 108 may be in contact with the wearer's face and the flange 108 may remain in contact with the wearer's face in instances in which the seal 130 may become separated therefrom.

In some embodiments, the seal 130 may include the same materials as the mask shell 102 and/or the flange 108. Alternatively or additionally, the seal 130 may include a soft, compressible sealant material configured to prevent airflow from an interior portion of the mask shell 102 to an exterior portion of the mask shell 102 and vice versa. For example, the seal 130 may include non-vulcanized latex rubber.

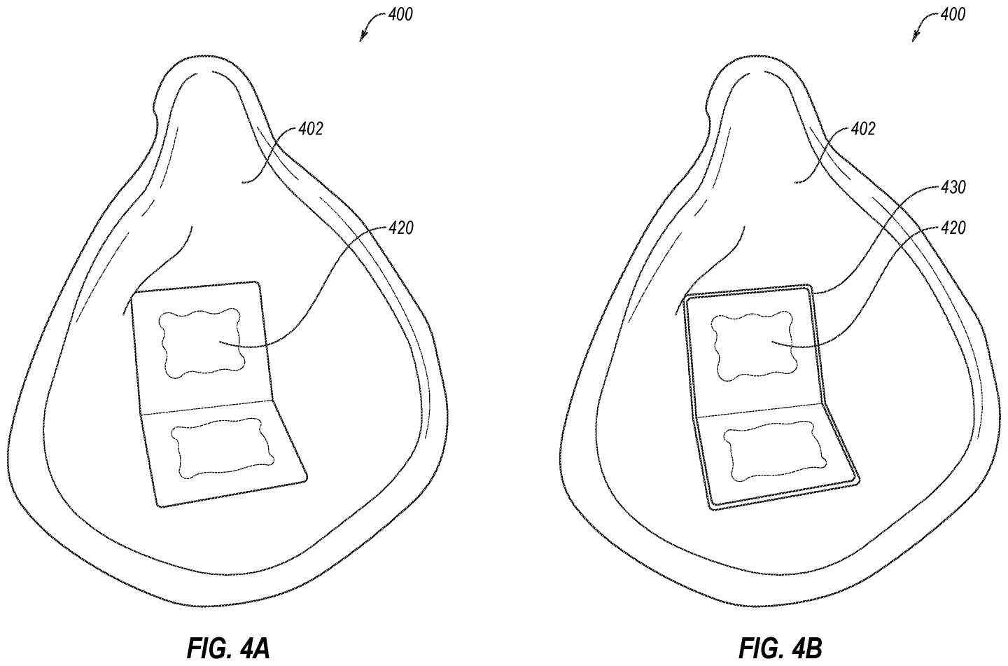

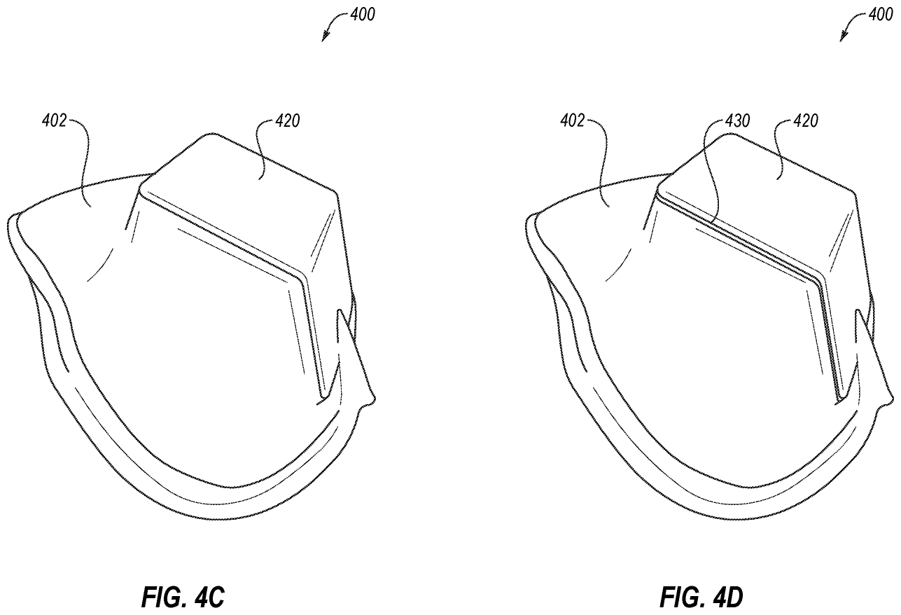

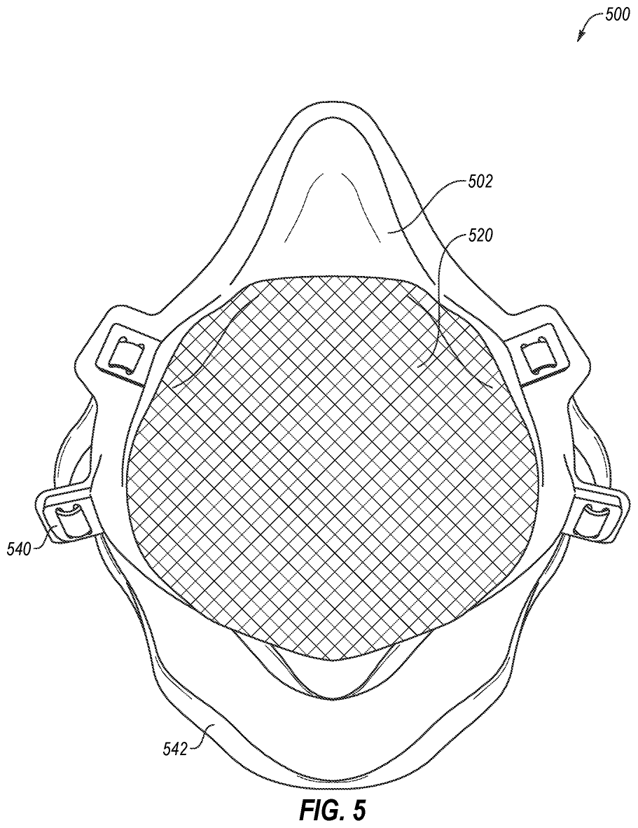

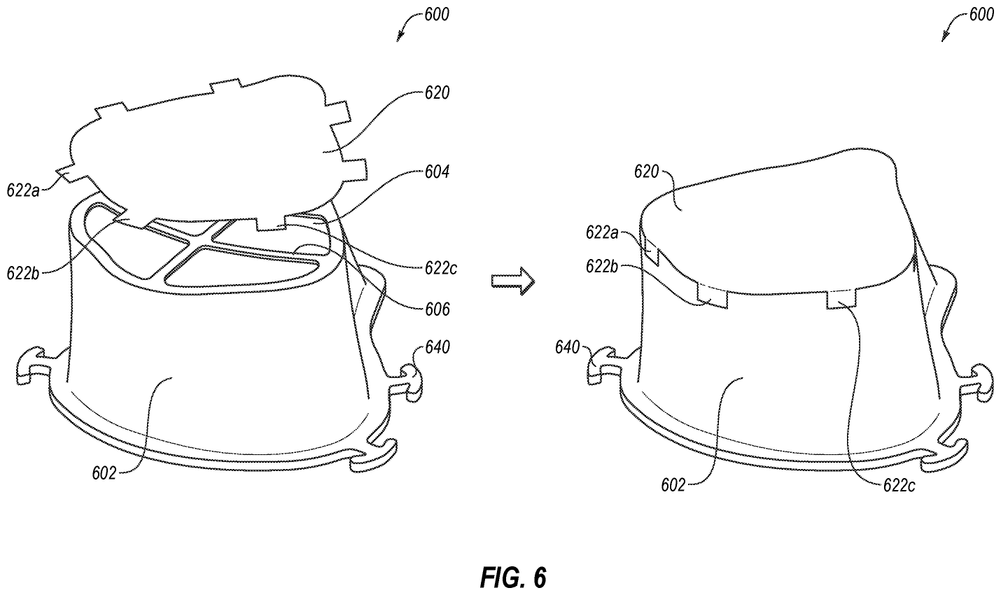

In some embodiments, the filter 120 may be configured to fit within the aperture 104. For example, in instances in which the aperture 104 is elevated from the outer surface of the mask shell 102, the filter 120 may fit within the aperture 104 and/or may be substantially flush with an inner surface of the mask shell 102 (e.g., the filter 420 of FIGS. 4A and 4B). Alternatively or additionally, the filter 120 may be configured to fit over the aperture 104. For example, in instances in which the aperture 104 is substantially planar with the outer surface of the mask shell 102, the filter 120 may be coupled to the mask shell 102 and may cover the aperture 104 (e.g., the filter 520 as shown in FIG. 5). In some embodiments, the filter 120 may include an adhesive surface that may couple the filter 120 to the mask shell 102, such that the filter 120 may be retained over the aperture 104 (e.g., the filter 620 as shown in in FIG. 6).

In some embodiments, the filter 120 may be replaceable within the face mask 100. For example, in instances in which the filter 120 becomes damaged, dirty, and/or the face mask 100 would otherwise benefit from replacing the filter 120, the filter 120 may be removed from the mask shell 102 and a new filter may be used with the face mask 100. In these and other embodiments, the other elements of the face mask 100, not the filter 120, may be usable with the face mask 100 and a replacement filter. Alternatively or additionally, the filter 120 may be removed from the mask shell 102 to be cleaned and reused with the face mask 100. For example, the filter 120 may be removed from the mask shell 102, cleaned in water and bleach solutions, water and soap solutions, and/or other disinfectants, and returned to the mask shell 102 to be used in the face mask 100.

FIG. 2 is an exploded, perspective view of an example embodiment of a face mask 200, in accordance with at least one embodiment described in the present disclosure. The face mask 200 may include a mask shell 202, an aperture 204, an aperture grille 206, a filter 220, a filter retaining member 222, an aperture portion 224, and one or more central supports 226.

In some embodiments, the face mask 200 may be analogous to the face mask 100. For example, the mask shell 202, the aperture 204, the aperture grille 206, and/or the filter 220 may be analogous to the mask shell 102, the aperture 104, the aperture grille 106, and/or the filter 120 of FIG. 1, respectively.

In some embodiments, the aperture grille 206 may be formed of the same material as the mask shell 202. For example, the mask shell 202 may include one or more strips of material that may be configured to cover the aperture 204, which may restrict the filter 220 from passing from an interior portion of the mask shell 202 to an exterior portion of the mask shell 202 through the aperture 204. In some embodiments, the aperture grille 206 may include various shapes and sizes and may be configured to permit air and/or gasses to pass through the filter 220 while retaining the filter 220 within the mask shell 202.

In some embodiments, the filter retaining member 222 may fit within the aperture 204 along with the filter 220, such that the filter retaining member 222 may be flush with the interior surface of the mask shell 202. Alternatively or additionally, the filter retaining member 222 may be recessed below the interior surface of the mask shell 202. For example, in instances in which the aperture 204 is included in a raised portion of the mask shell 202, the filter 220 may be disposed between the filter retaining member 222 and the aperture 204 in the raised portion thereof such that the filter retaining member 222 is flush or recessed with respect to the interior surface of the mask shell 202. In some embodiments, the filter retaining member 222 may couple to the mask shell 202 to retain the filter 220 in place covering the aperture 204. For example, in instances in which the filter retaining member 222 is configured to fit within the raised portion of the mask shell 202, the filter retaining member 222 may secure the filter 220 within the aperture 204 by one or more mechanical features such as friction between the filter retaining member 222 and the mask shell 202, adhesives, detents on the filter retaining member 222 and the mask shell 202, and/or other similar coupling mechanisms.

In some embodiments, the filter retaining member 222 may include the aperture portion 224 such that the filter retaining member 222 may contact the filter 220 on an edge portion thereof, such that inhaled and/or exhaled air may pass through the filter 220 without obstruction from the filter retaining member 222. Alternatively or additionally, the filter retaining member 222 may include the one or more central supports 226 that may provide additional structure to the filter retaining member 222. For example, a central portion of the filter retaining member 222 may include the one or more central supports 226 that may contribute to the filter retaining member 222 in maintaining its shape.

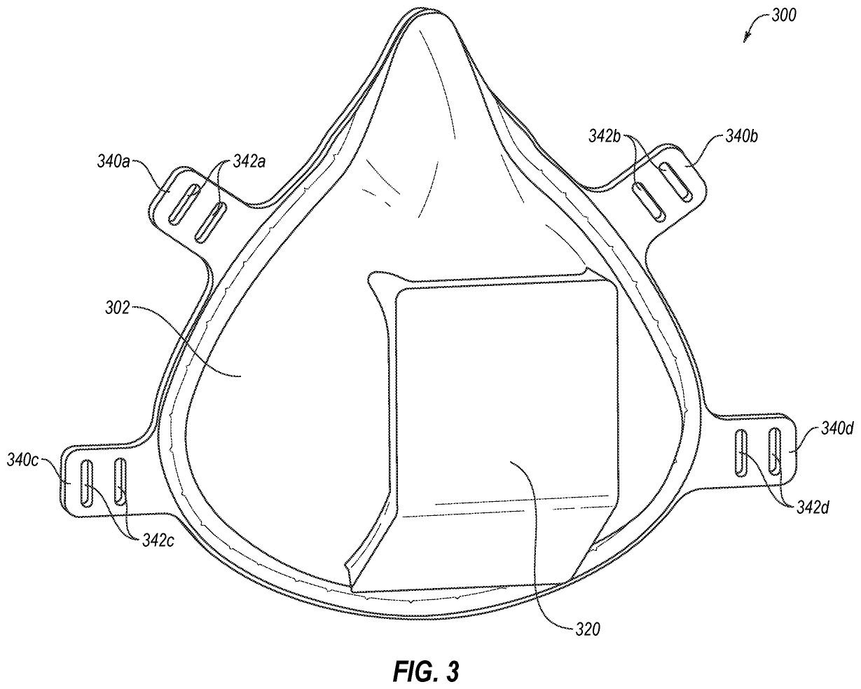

FIG. 3 is a perspective view of an example embodiment of a face mask 300, in accordance with at least one embodiment described in the present disclosure. The face mask 300 may include a mask shell 302, a filter 320, a first tie attachment member 340a, a second tie attachment member 340b, a third tie attachment member 340c, a fourth tie attachment member 340d, collectively, tie attachment members 340, and first channels 342a, second channels 342b, third channels 342c, and fourth channels 342d, collectively channels 342.

In some embodiments, the face mask 300 may be analogous to the face mask 100. For example, the mask shell 302 and/or the filter 320 may be similar or analogous to the mask shell 102 and/or the filter 120 of FIG. 1.

In some embodiments, the tie attachment members 340 may be coupled to the mask shell 302 on a lateral edge thereof. Alternatively or additionally, the tie attachment members 340 may be on the surface of the mask shell 302. Alternatively or additionally, the mask shell 302 may not include tie attachment members 340 (e.g., see FIGS. 1A, 2, and 11). In some embodiments, the tie attachment members 340 may include hooks for elongated attachment members (e.g., elongated attachment members 542 of FIG. 5 and elongated attachment members 842 of FIG. 8) to attach to, such that the elongated attachment members may loop around the wearer's ears, neck, head, and/or combinations thereof. Alternatively or additionally, the tie attachment members 340 may define the channels 342, which may be disposed in one or more flaps of the tie attachment members 340, where the channels 342 may be configured to receive the elongated attachment members. In some embodiments, the elongated attachment members may be fed through the channels 342 of the tie attachment members 340, and the elongated attachment members may loop around the wearer's ears, neck, head, and/or combinations thereof to couple the face mask 300 to the wearer's face.

In some embodiments, a filter retaining member may be combined with the filter 320. In some embodiments, a combination of the filter retaining member and the filter 320 may couple to the mask shell 302 such that the filter 320 and/or the mask shell 302 may include projections and depressions, detents, friction elements, and/or other similar resistance elements, such that the filter 320 may be retained in the mask shell 302 over an aperture of the mask shell 302. For example, the filter 320 may be configured to snap into the mask shell 302 such that the filter 320 may be retained in the mask shell 302 until a deliberate attempt to remove the filter 320 from the mask shell 302 by the wearer.

FIGS. 4A, 4B, 4C, and 4D are two rear views and two perspective views, respectively, of an example embodiment of a face mask 400, in accordance with at least one embodiment described in the present disclosure. The face mask 400 may include a mask shell 402, a filter 420, and a gasket 430.

In some embodiments, the face mask 400 may be analogous to the face mask 300. For example, the mask shell 502 and/or the filter 520 may be similar or analogous to the mask shell 302 and/or the filter 320 of FIG. 3.

In some embodiments, the filter 420 may include the gasket 430 on an exterior edge, which gasket 430 may be configured to create a seal between the filter 420 and the mask shell 402. In some embodiments, the gasket 430 may be located between the filter 420 and the mask shell 402 and may prevent the ingress and/or egress of liquids and/or gasses between the filter 420 and the mask shell 402 and/or direct the flow of liquids and/or gasses through the filter 420.

In some embodiments, the filter 420 and/or the gasket 430 may be configured to provide an indication as to whether the filter 420 is properly aligned with an aperture of the mask shell 402. For example, in instances in which the one or more coupling members of the filter 420 interface with the one or more coupling members of mask shell 402, a visual indication may be visible and/or an audible indication may be produced.

In some embodiments, the gasket 430 may not be visible from an interior portion of the mask shell 402 in instances in which the filter 420 is improperly aligned with the aperture of the mask shell 402, such as shown in FIG. 4A. Alternatively or additionally, the gasket 430 may not be visible from an exterior portion of the mask shell 402 in instances in which the filter 420 is improperly aligned with the aperture of the mask shell 402, such as shown in FIG. 4C.

In some embodiments, the gasket 430 may be visible from an interior portion of the mask shell 402 in instances in which the filter 420 is properly aligned with the aperture of the mask shell 402, such as shown in FIG. 4B. Alternatively or additionally, the gasket 430 may be visible from an exterior portion of the mask shell 402 in instances in which the filter 420 is properly aligned with the aperture of the mask shell 402, such as shown in FIG. 4D.

FIG. 5 is a front view of an example embodiment of a face mask 500, in accordance with at least one embodiment described in the present disclosure. The face mask 500 may include a mask shell 502, a filter 520, tie attachment members 540, and elongated attachment members 542.

In some embodiments, the face mask 500 may be analogous to the face mask 300. For example, the mask shell 502, the filter 520, and/or the tie attachment members 540 may be similar or analogous to the mask shell 302, the filter 320, and/or the tie attachment members 340. Alternatively or additionally, the filter 520 may be sized and shaped to cover a larger portion of the mask shell 502. In some embodiments, the filter 520 may be formed of a flexible material such that the filter 520 bends and moves as the mask shell 502 bends and moves.

In some embodiments, the tie attachment members 540 may include hooks for elongated attachment members 542 to attach to, such that the elongated attachment members 542 may loop around the wearer's ears, neck, head, and/or combinations thereof. Alternatively or additionally, the tie attachment members 540 may include one or more flaps, which flaps may include one or more channels configured to receive the elongated attachment members 542, such that the elongated attachment members may be fed through the channels of the tie attachment members 540, and the elongated attachment members 542 may loop around the wearer's ears, neck, head, and/or combinations thereof.

In some embodiments, the elongated attachment members 542 may include materials that may be stretched or tightened such that the face mask 500 may be coupled to the wearer's face. Alternatively or additionally, the elongated attachment members 542 may include fabric materials that may loop around the wearer's ears, neck, head, and/or combinations thereof. For example, the elongated attachment members 542 may include two or more ends of fabric, such as cotton, nylon, and/or other similar fabrics, that may be configured to wrap around the wearer's head and/or neck, and the two or more ends of fabric may be joined together with an adhesive, hook and loop, and/or other similar attachment members.

FIG. 6 is a perspective view of an example embodiment of a face mask 600 with a replaceable filter 620, in accordance with at least one embodiment described in the present disclosure. The face mask 600 may include a mask shell 602, an aperture 604, an aperture grille 606, a first tab 622a, a second tab 622b, a third tab 622c, collectively, tabs 622, and tie attachment members 640.

In some embodiments, the mask shell 602 may be analogous to the mask shell 102 of FIG. 1. The mask shell 602 may illustrate a shape variation that may be implemented with a face mask, such as face mask 600. Alternatively or additionally, the aperture 604 and/or the aperture grille 606 may be analogous to the aperture 104 and/or the aperture grille 106 of FIG. 1 and may illustrate a shape variation that the aperture 604 and/or the aperture grille 606 may implement as part of the face mask 600. Alternatively or additionally, the tie attachment members 640 may be analogous to the tie attachment members 340 of FIG. 3 and may illustrate a variation that the tie attachment members 640 may implement as part of the face mask 600.

In some embodiments, the filter 620 may be stretchable which may contribute to the filter 620 covering the aperture 604. For example, in instances in which the filter 620 is marginally smaller than the aperture 604, the filter 620 may be stretched to fully cover the aperture 604. Alternatively or additionally, the filter 620 may be coupled to a stretchable material such that the stretchable material stretches while the filter 620 remains unstretched. For example, the filter 620 may be coupled to a bandage-like material that may be stretched and coupled to the mask shell 602 such that the filter 620 covers the aperture 604, and the filter 620 remains unstretched. Alternatively or additionally, the filter 620 may include stretchable distal members that may include an adhesive surface to couple the filter 620 to the mask shell 602 and cover the aperture 604 thereof, such that a portion of the filter 620 that covers the aperture 604 remains unstretched while the stretchable distal members may be stretched and coupled to the mask shell 602. For example, the filter 620 may include the tabs 622 located on an edge and/or a distal portion of the filter 620 which tabs 622 may be stretchable as needed to attach the filter 620 to the mask shell 602 without distorting the shape and/or effectiveness of the filter 620.

In some embodiments, a bandage-like material may be configured to couple to an outer surface of the mask shell 602 and may be configured to hold the filter 620 in place over the aperture 604. For example, the bandage-like material may include an adhesive side that may cover a lateral portion of the filter 620 and may couple to the outer surface of the mask shell 602. In these and other embodiments, the bandage-like material may couple the lateral edges of the filter 620 to the mask shell 602 such that the bandage-like material may not cover the aperture 604.

In some embodiments, the bandage-like material may include a bridging connection (not shown) that may couple to the bandage-like material at or near where the bandage-like material couples to the lateral edges of the filter 620. In some embodiments, the bridging connection may include two or more material members that may couple to the bandage-like material at or near the where the bandage-like material couples to the lateral edges of the filter 620. Alternatively or additionally, the bridging connection may include more than two material members that may be coupled to the bandage-like material. In these and other embodiments, the material members of the bridging material may be configured to coupled together in a central portion of the bandage-like material, such as disposed over the filter 620.

In some embodiments, the bridging connection may be configured to reduce and/or limit the amount of separation between the bandage-like material and the filter 620. For example, the bridging connection may reduce an amount of lateral movement of the bandage-like material relative to the filter 620, such that the bandage-like material may remain coupled to the filter 620.

In some embodiments, the bridging connection may include materials configured to permit airflow such as inhaling and exhaling from the wearer of the face mask 600. For example, the bridging connection may include cotton, polyester, nylon, and/or other similar materials. Alternatively or additionally, the bridging connection may include the same materials as the filter 620. In these and other embodiments, the bridging connection may be configured to not attach or couple to the filter 620. For example, the bridging connection may include similar materials as the bandage-like material any may not include an adhesive side that the bandage-like material may include.

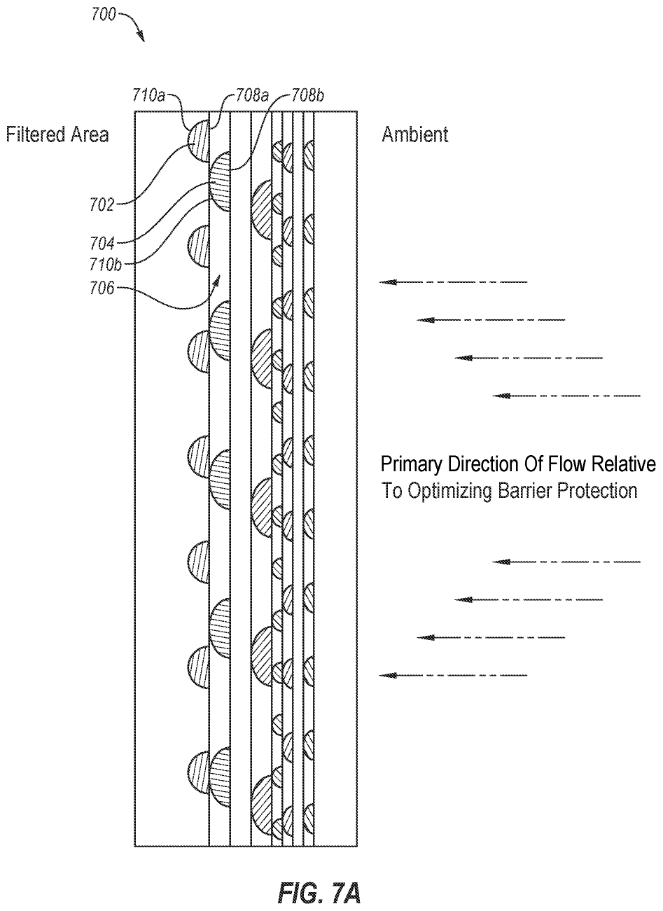

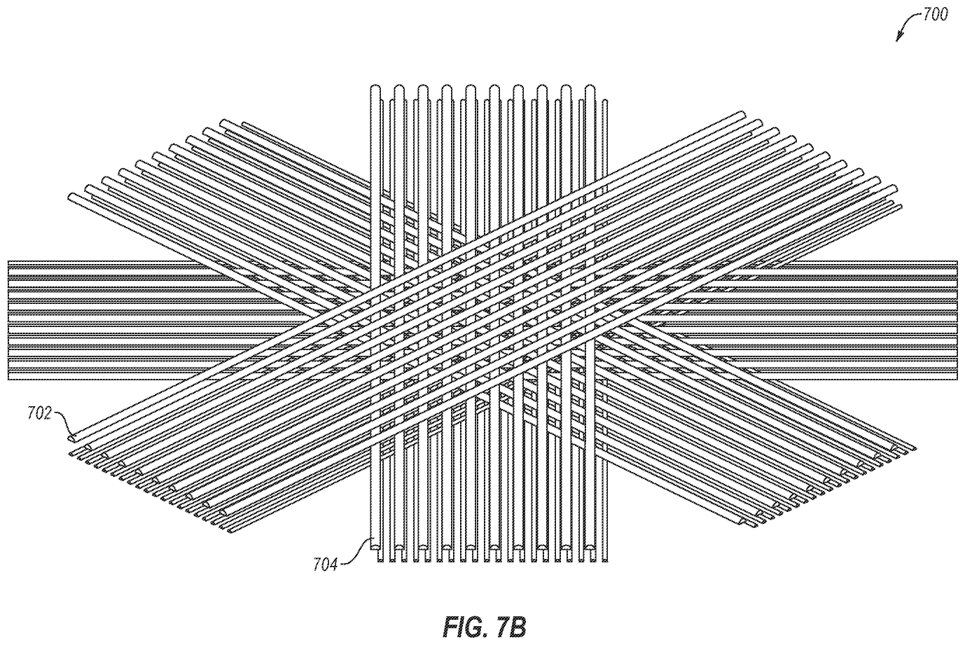

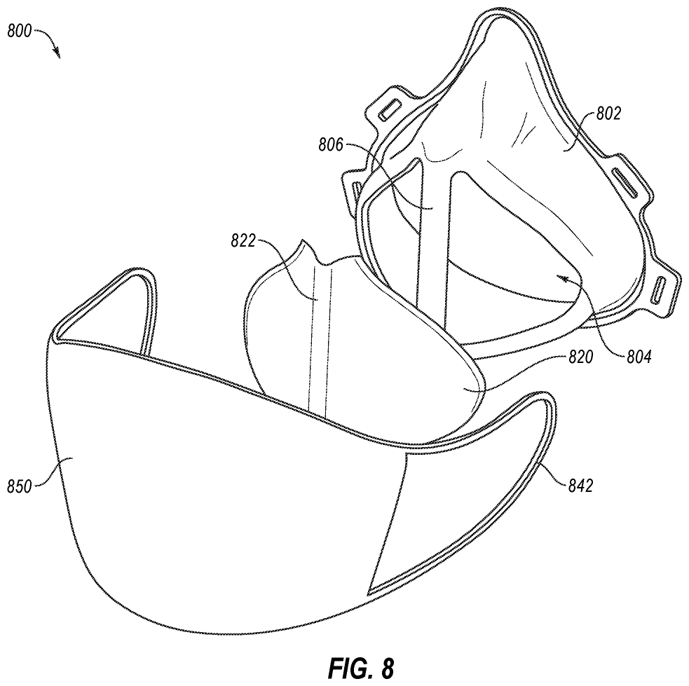

FIG. 7A is a cross-sectional view of an example filter 700 that may be used with a face mask and FIG. 7B is perspective view of the example filter 700, in accordance with at least one embodiment described in the present disclosure. The filter 700 may include first semicircular fibers 702, second semicircular fibers 704, filter chamber 706, a first flat portion 708a, a second flat portion 708b, a first rounded portion 710a, and a second rounded portion 710b.

In some embodiments, the filter 700 may include the first semicircular fibers 702 and the second semicircular fibers 704 that may be arranged in layers to form a grid-like structure. In some embodiments, the first semicircular fibers 702 may include the first flat portion 708a and the first rounded portion 710a where the fibers of the first semicircular fibers 702 may be arranged parallel to each other. In some embodiments, a second semicircular fibers 704 may be analogous to the first semicircular fibers 702, such as including the second flat portion 708b and the second rounded portion 710b. Alternatively or additionally, the second semicircular fibers 704 may include a larger or smaller diameter than the first semicircular fibers 702.

In some embodiments, the first flat portion 708a of the first semicircular fibers 702 may be coupled to the second rounded portion 710b of the second semicircular fibers 704. For example, the first semicircular fibers 702 may be disposed on the second semicircular fibers 704 and the two layers may be coupled together. In some embodiments, the layers of semicircular fibers may be coupled using heat and/or chemical bonding at predetermined intervals. For example, the first semicircular fibers 702 may be bonded to the second semicircular fibers 704 at one-micron intervals.

In some embodiments, the semicircular fibers may be arranged such that the first flat portion 708a and the second flat portion 708b of the semicircular fibers may be oriented away from the wearer of the face mask 100 and the first rounded portion 710a and the second rounded portion 710b may be oriented toward the wearer of the face mask 100.

In some embodiments, the first semicircular fibers 702 and the second semicircular fibers 704 may form the filter chamber 706 between the layers of semicircular fibers. Alternatively or additionally, in instances where more than two layers of semicircular fibers are used in the filter 700, the filter chamber 706 may be formed between each layer of multiple semicircular fibers 702, 704.

In some embodiments, the first semicircular fibers 702 may be disposed on the second semicircular fibers 704 at a rotational offset, as shown in FIG. 7B. For example, the first semicircular fibers 702 may include a first orientation and the second semicircular fibers 704 may include a second orientation that is oblique to the first orientation. The amount of rotational offset between the first semicircular fibers 702 and the second semicircular fibers 704 may be any amount between zero and ninety degrees. In some embodiments, in instances in which there are more than two layers of semicircular fibers, each layer of the semicircular fibers may include a rotational offset such that none of the layers of the semicircular fibers may include identical orientations. Alternatively or additionally, in instances in which there are more than two layers of semicircular fibers, the orientation of successive layers of the semicircular fibers may include the same orientation. For example, in instances in which eight layers of the semicircular fibers are included in the filter 700, the first and fifth layers of semicircular fibers may include the same orientation, the second and sixth layers of semicircular fibers may include the same orientation, and so forth.

In some embodiments, the first semicircular fibers 702 may include non-woven thermoplastic materials. For example, the first semicircular fibers 702 may include polypropylene materials. Alternatively or additionally, the first semicircular fibers 702 may include a surface treatment coating that may increase the hydrophobicity of the filter 700. For example, the first semicircular fibers 702 of the filter 700 may be treated with zwitterionic polycarboxybetaine. In these and other embodiments, the second semicircular fibers 704 may include similar materials and/or a similar treatment as the first semicircular fibers 702.

FIG. 8 is an exploded, perspective view of an example embodiment of a face mask 800, in accordance with at least one embodiment described in the present disclosure. The face mask 800 may include a mask shell 802, an aperture 804, a shell coupling member 806, a filter 820, a filter coupling member 822, elongated attachment members 842, and a cloth cover 850.

In some embodiments, the mask shell 802 may include one or more shell coupling members 806. For example, the one or more shell coupling members 806 of the mask shell 802 may include projections, depressions, bumps, and/or other variations in the surface of the mask shell 802. In some embodiments, the one or more shell coupling members 806 of the mask shell 802 may be adjacent to the aperture 804. Alternatively or additionally, the one or more shell coupling members 806 may be disposed at various locations on the mask shell 802. The one or more shell coupling members 806 may contribute to a proper alignment of the filter 820 to the aperture 804, in conjunction with the one or more filter coupling members 822. For example, in instances in which a vertical divider is used to divide the aperture 804, the vertical divider may include a raised portion that acts as a shell coupling member 806, such that the raised portion may be used to align the filter 820 with the aperture 804 by way of the filter coupling member 822. In instances in which the aperture 804 includes an aperture grille and/or when there is no material in front of the aperture 804, the one or more shell coupling members 806 may include one or more small, raised portions (e.g. bumps on the surface of the mask shell 802) on the aperture grille and/or around the edge of the aperture 804.

In some embodiments, the one or more shell coupling members 806 may be configured to couple the filter 820 to the mask shell 802, such as by coupling with the filter coupling member 822. Alternatively or additionally, the one or more shell coupling members 806 may be used to align the filter 820 with the aperture 804 by interfacing with the one or more filter coupling members 822.

In some embodiments, the filter 820 may include the one or more filter coupling members 822 that may be configured to align and/or interface with the shell coupling member 806, such that the filter 820 is positioned to cover the aperture 804. For example, in instances in which the shell coupling member 806 includes a projection that is a vertical divider with a raised portion, the filter coupling member 822 may include a complimentary vertical depressed portion, such that the filter 820 may be aligned with and cover the aperture 804.

In some embodiments, the cloth cover 850 may be configured to at least partially cover the mask shell 802 when in use by the wearer of the face mask 800. In some embodiments, the cloth cover 850 may partially cover the mask shell 802. Alternatively or additionally, the cloth cover 850 may fully cover the mask shell 802 when in use by the wearer of the face mask 800.

In some embodiments, one or more elongated attachment members 842 may be configured to couple to the cloth cover 850. Alternatively or additionally, the one or more elongated members 842 may be configured to couple the cloth cover 850 to the wearer's face and/or head. For example, the one or more elongated members 842 may loop over and/or around the wearer's ears, and/or around the wearer's head and/or neck. In these and other embodiments, the one or more elongated members 842 may be analogous to the elongated attachment members 542 of FIG. 5.

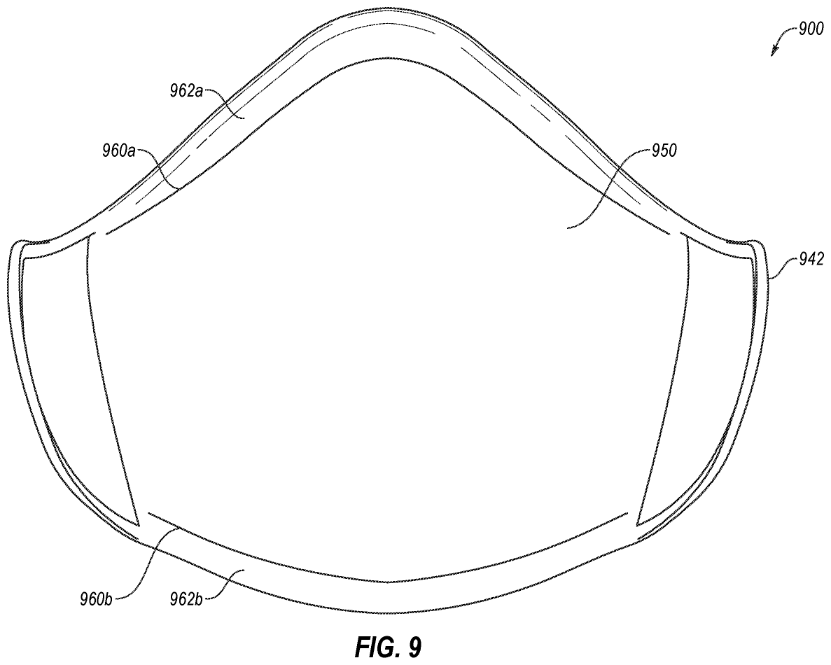

FIG. 9 is a rear view of an example cloth mask 900, such as the cloth cover 850 of the face mask of FIG. 8, in accordance with at least one embodiment described in the present disclosure. The cloth mask 900 may include one or more elongated members 942, a cloth cover 950, an upper hem 960a, a lower hem 960b, an upper channel 962a, and a lower channel 962b.

In some embodiments, the one or more elongated members 942 may be analogous to the elongated attachment members 542 of FIG. 5. Alternatively or additionally, the cloth cover 950 may be analogous to the cloth cover 850 of FIG. 8.

In some embodiments, the cloth cover 950 may include the upper hem 960a on a superior portion thereof and/or the lower hem 960b on an inferior portion thereof. For example, the cloth cover 950 may include the upper hem 960a along an upper edge and/or may include the lower hem 960b along a lower edge. In some embodiments, the upper hem 960a and/or the lower hem 960b may include the upper channel 962a and/or the lower channel 960b, respectively, formed by the upper hem 960a and/or the lower hem 960b. For example, one or more edges of the cloth cover 950 may be folded over and hemmed such that the upper channel 962a may be formed by the upper edge of the cloth cover 950 and the upper hem 960a and the lower channel 962b may be formed by the lower edge of the cloth cover 950 and the lower hem 960b.

In some embodiments, one or more flexible rods (not shown) may be inserted in the one or more channels 962 formed by the one or more hems 960. For example, a first flexible rod may be inserted in a channel 962 formed by the hem 960 in the upper edge of the cloth cover 950 and a second flexible rod may be inserted in a channel 962 formed by the hem 960 in the lower edge of the cloth cover 950. In some embodiments, the one or more flexible rods may be used to form the edges of the cloth cover 950 to the contour of the wearer's face. For example, the one or more flexible rods may be bent, shaped, curved, and/or otherwise adjusted to the contour of the wearer's face.

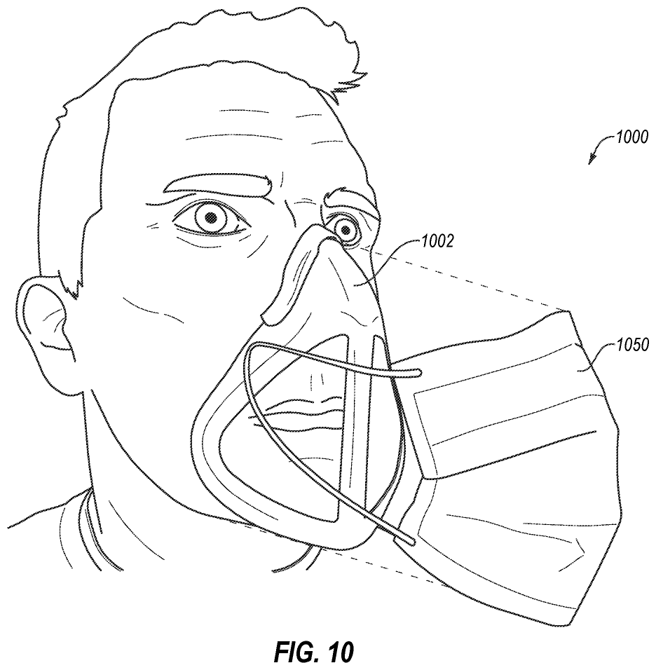

FIG. 10 is an exploded, perspective view of an example embodiment of a face mask 1000, in accordance with at least one embodiment described in the present disclosure. The face mask 1000 may include a mask shell 1002 and a cover 1050.

In some embodiments, the mask shell 1002 may be analogous to the mask shell 802 of FIG. 8. In some embodiments, the cover 1050 may be analogous to the cloth cover 950 of FIG. 9. Alternatively or additionally, the cover 1050 may include a filtering mask that may be include an over-the-counter face mask that includes filtering materials, such as an N95 mask or a surgical mask.

In some embodiments, the combination of the mask shell 1002 and the cover 1050 may increase the effectiveness of the cover 1050 by creating a more secure fit around the wearer's nose and mouth and directing air flow (such as from breathing) through the cover 1050 for filtering. Alternatively or additionally, the mask shell 1002 may contribute to easier breathing by creating and maintaining a cavity around the wearer's nostrils and/or mouth without obstruction from the cover 1050.

Terms used herein and especially in the appended claims (e.g., bodies of the appended claims) are generally intended as “open” terms (e.g., the term “including” should be interpreted as “including, but not limited to,” the term “having” should be interpreted as “having at least,” the term “includes” should be interpreted as “includes, but is not limited to,” etc.).

Additionally, if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations.

In addition, even if a specific number of an introduced claim recitation is explicitly recited, it is understood that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” or “one or more of A, B, and C, etc.” is used, in general such a construction is intended to include A alone, B alone, C alone, A and B together, A and C together, B and C together, or A, B, and C together, etc. For example, the use of the term “and/or” is intended to be construed in this manner.

Further, any disjunctive word or phrase presenting two or more alternative terms, whether in the description, claims, or drawings, should be understood to contemplate the possibilities of including one of the terms, either of the terms, or both terms. For example, the phrase “A or B” should be understood to include the possibilities of “A” or “B” or “A and B.”

Additionally, the use of the terms “first,” “second,” “third,” etc., are not necessarily used herein to connote a specific order or number of elements. Generally, the terms “first,” “second,” “third,” etc., are used to distinguish between different elements as generic identifiers. Absence a showing that the terms “first,” “second,” “third,” etc., connote a specific order, these terms should not be understood to connote a specific order. Furthermore, absence a showing that the terms first,” “second,” “third,” etc., connote a specific number of elements, these terms should not be understood to connote a specific number of elements. For example, a first widget may be described as having a first side and a second widget may be described as having a second side. The use of the term “second side” with respect to the second widget may be to distinguish such side of the second widget from the “first side” of the first widget and not to connote that the second widget has two sides.

All examples and conditional language recited herein are intended for pedagogical objects to aid the reader in understanding the invention and the concepts contributed by the inventor to furthering the art, and are to be construed as being without limitation to such specifically recited examples and conditions. Although embodiments of the present disclosure have been described in detail, it should be understood that the various changes, substitutions, and alterations could be made hereto without departing from the spirit and scope of the present disclosure.

What is claimed is:

1. A face mask comprising:
a mask shell defining a cavity configured to at least partially receive a wearer's nostrils and mouth, comprising:
an aperture formed in the mask shell; and
a flange disposed on an inner portion of an edge of the mask shell, the flange configured to follow a contour of the wearer's face, wherein the flange is configured to contact the wearer's face at least at a nasal bridge portion, a chin portion, a left cheek portion, and a right cheek portion; and
a replaceable filter coupled to the mask shell, configured to cover the aperture.

2. The face mask of claim 1, further comprising a seal disposed on the edge of the mask shell.

3. The face mask of claim 1, further comprising one or more tie attachment members on the mask shell.

4. The face mask of claim 3, further comprising one or more elongated attachment members coupled to the tie attachment members of the mask shell.

5. The face mask of claim 1, further comprising a pressure release valve extending through the mask shell.

6. The face mask of claim 1, wherein the mask shell is formed of a thermoplastic material.

7. The face mask of claim 6, wherein the thermoplastic material includes one of low-density polyethylene, polyvinylidene fluoride, or polyethylene terephthalate.

8. The face mask of claim 1, further comprising a filter retaining member configured to be coupled to the mask shell, the filter retaining member configured to fit and be retained in the aperture, the filter retaining member configured to secure the replaceable filter covering the aperture.

9. The face mask of claim 1, further comprising a cloth covering configured to at least partially cover the mask shell and the replaceable filter, comprising:
one or more elongated attachment members coupled to the cloth covering to couple the cloth covering to the wearer's face;
a first hem on a first edge of the cloth covering, forming a first channel;
a second hem on a second edge of the cloth covering, forming a second channel;
a first flexible rod disposed in the first channel; and
a second flexible rod disposed in the second channel,
wherein the first flexible rod is shaped to the contour of the wearer's nasal bridge portion and the second flexible rod is shaped to the contour of the wearer's chin portion.

10. The face mask of claim 1, further comprising:
a first coupling member disposed on the mask shell; and
a second coupling member disposed on the replaceable filter,
wherein the first coupling member is configured to interface with the second coupling member such that the replaceable filter is aligned with the aperture on the mask shell.

11. The face mask of claim 1, wherein an aperture grille is disposed in the aperture of the mask shell.

12. The face mask of claim 1, wherein the replaceable filter provides a first indication signifying the replaceable filter is properly aligned.

13. A face mask comprising:
a mask shell defining a cavity configured to at least partially receive a wearer's nostrils and mouth, the mask shell configured to follow the contour of the wearer's face, wherein the mask shell is configured to contact the wearer's face at least at a nasal bridge portion, a chin portion, a left cheek portion, and a right cheek portion, comprising:
an aperture formed in the mask shell;
a first coupling member located adjacent to the aperture; and
one or more tie attachment members;
a replaceable filter configured to cover the aperture, having a second coupling member complimentary to the first coupling member, such that the replaceable filter covers the aperture when the first coupling member interfaces with the second coupling member; and
one or more elongated attachment members coupled to the one or more tie attachment members.

14. The face mask of claim 13, wherein the mask shell is formed of a clear, low-density polyethylene material.

15. A reusable filter comprising:
a first plurality of semicircular fibers having a first flat portion and a rounded portion, wherein the first plurality of semicircular fibers are parallel to each other and the first flat portion of the first plurality of semicircular fibers lies in a first plane; and
a second plurality of semicircular fibers having a second flat portion, wherein the second plurality of semicircular fibers are parallel to each other and the second flat portion of the second plurality of semicircular fibers lies in a second plane,
wherein the first plurality of semicircular fibers are disposed on and coupled to the second plurality of semicircular fibers at a rotational offset, such that the first plane is parallel and superior to the second plane and the first plurality of semicircular fibers and the second plurality of semicircular fibers define a filter chamber.

16. The reusable filter of claim 15, further comprising:
a third plurality of semicircular fibers having a third flat portion, wherein the second plurality of semicircular fibers are parallel to each other and the third flat portion of the third plurality of semicircular fibers lies in a third plane,
wherein the second plurality of semicircular fibers are disposed on and coupled to the third plurality of semicircular fibers at a rotational offset, such that the second plane is parallel and superior to the third plane and the second plurality of semicircular fibers and the third plurality of semicircular fibers define a second filter chamber.

17. The reusable filter of claim 15, wherein the rounded portion of the first plurality of semicircular fibers is coupled to the second flat portion of the second plurality of semicircular fibers.

18. The reusable filter of claim 15, wherein the first plurality of semicircular fibers and the second plurality of semicircular fibers are formed of polypropylene.

19. The reusable filter of claim 18, wherein the first plurality of semicircular fibers and the second plurality of semicircular fibers are treated with zwitterionic polycarboxybetaine.

20. The reusable filter of claim 15, wherein the first plurality of semicircular fibers are coupled to the second plurality of semicircular fibers at predetermined intervals.
